(19) United States
(12) Patent Application Publication
(10) Pub. No.: US 2014/0278049 A1
(43) Pub. Date: Sep. 18, 2014

(54) Grid-Based Environmental Model for a Vehicle

(71) Applicants: Conti Temic microelectronic GmbH, Nuernberg (DE); Continental Teves AG & Co. oHG, Frankfurt (DE)

(72) Inventors: Ralph Grewe, Lindau (DE); Stefan Hegemann, Wangen (DE); Andree Hohm, Obernburg (DE); Stefan Lueke, Bad Homburg (DE)

(21) Appl. No.: 14/352,568

(22) PCT Filed: Sep. 20, 2012
(86) PCT No.: PCT/DE2012/100292

§ 371 Date: Apr. 17, 2014

(30) Foreign Application Priority Data
Oct. 28, 2011 (DE) 10 2011 117 138.3

(51) Int. Cl. G08G 1/16

(52) U.S. Cl. CPC G08G 1/16
USPC 701/301

(57) ABSTRACT

A sensor system for sensing the environment of a motor vehicle having has an evaluation unit, wherein a grid-based environmental model is calculated and at least one discrete value of environmental data is assigned to each grid cell. Discretization is carried out by comparing the environmental data with at least one threshold value. At least one discrete value of the grid is preferably transmitted via a data transmission system to an evaluation or control unit in the vehicle.

The invention is in the technical field of sensing the environment with sensors in a vehicle. The sensor data are processed in suitable manner to provide an environmental model for further applications in particular driver assistance functions.

State of the art is for example a grid-based environmental model. For this purpose the environment of a vehicle is divided into cells and for each cell one or more features for describing the environment are stored. Furthermore, object-based methods for environmental modeling, which provide the position data of detected objects belong to the state of the art.

An advantage of the grid-based method is that the entire environment of the vehicle is described. Information is provided from sensor data for free and object-occupied and unknown areas rather than for areas occupied with objects (object-based method) in the environmental model. The explicit modeling of free areas becomes increasingly important, since many newer assistance functions, such as e.g. an avoidance assistant, require information on a free space, which can be used as a maneuver space for the vehicle. Grid-based methods for describing the environment usually require a larger amount of data than object-based methods and thus an application in the vehicle requires larger storage resources and transmission bandwidths.

It is the object of the present invention to compress the data of a grid-based environmental model such that a use in the vehicle and in particular a transmission of the environmental model data via conventional vehicle bus systems is possible between control units.

This object is achieved by the features of the independent claims.

A method for a sensor system for sensing the environment of a motor vehicle is claimed, wherein a grid-based environmental model is calculated. A grid-based environmental model is based on the fact to divide the environment of a vehicle into cells and to store for each cell a feature describing the environment. Storing raw sensor data or storing a classification for each cell as a probability value, e.g. storing the probability that a cell is occupied or not, requires a high storage capacity, which with a transmission from or to a control unit in addition needs a bus system with a high bandwidth.

According to the invention at least one discrete value (class) is assigned to each grid cell. In particular, the discrete value or class is a measure of whether an object is located at the position represented by the grid cell and whether this object can be crossed or with which probability the object can be crossed. Discretization or association of a class is carried out by evaluating the environmental data, which contains statements on sensed environmental objects and at least one threshold value. The number of threshold values can be defined arbitrarily and influences the number of possible classes. With a threshold value maximal two discrete values or classes, with two threshold values maximal three discrete values or classes can be limited.

Preferably, a lossless compression method is applied to the discrete values of a grid, in particular prior to a transmission via a data transmission system in the vehicle. This includes also grid values, which have been compressed prior to a transmission.

In a preferred embodiment of the invention a compression of the data is achieved by decorrelating the temporal dependence, i.e. by forming a difference of successive discrete values of the grid cells. In particular, only the difference values are transmitted in the vehicle via a data transmission system.

In a further positive embodiment of the invention, a lossy compression method is applied to the discrete values of a grid, in particular prior to a transmission via a data transmission system in the vehicle.

Particularly, for this purpose the discrete values of the grid, which represent areas further away from the vehicle, are more compressed.

Preferably, alternatively or additionally, the discrete values of the grid, which represent features facing away from the vehicle, are more compressed. For example, the back side of a construction site wall, which is arranged facing away from the vehicle, is more compressed than the front side of the construction site wall, which is arranged facing the vehicle. A particularly computationally efficient embodiment of the invention provides that the assignment of the discrete value or class is effected on the basis of the environmental data by means of an assignment table, wherein the assignment table is stored in the memory of the evaluation unit. In a preferred embodiment of the invention the assignment table is changed to modify the contents of a plurality of grid cells. By the modified assignment rule which can assign a changed value range of the environmental data to a discrete value or a class, the contents of all cells can be changed all at once, without having to recalculate and overwrite the discrete values in each grid cell.

In a preferred embodiment of the invention, based on discrete values in the grid the environmental model is transmitted via a data transmission system in a vehicle to an evaluation or control unit. The data transmission system is preferably a bus system in the vehicle, which connects at least two evaluation or control units. Preferably, one evaluation unit creates the grid-based environmental model and a further evaluation or control unit uses the environmental model for controlling a driver assistance function.

The invention claimed here comprises a sensor system for sensing objects of a vehicle having a first computing and evaluation unit, on which a method as previously described is stored.

In particular, a second evaluation or control unit and a data transmission system are provided, wherein via the data transmission system the first is connected to the second evaluation or control unit in a vehicle.

In a preferred embodiment of the invention, the first evaluation or control unit is provided for creating an environmental model and the second evaluation or control unit is provided for controlling a driver assistance system.

The invention is explained in more detail below on the basis of examples of embodiment and accompanying drawings.

A grid-based environmental model is based on the fact to divide the environment of a vehicle into cells and to store for each cell a feature describing the environment. Storing raw sensor data or storing a classification for each cell as a probability, e.g. the probability that a cell is occupied or not, requires a high storage capacity, which with a transmission from or to a control unit in addition needs a bus system with a high bandwidth. A direct application of a compression method to a calculated grid often does not lead to a high compression factor, as the probabilities of adjacent cells often differ only marginally. As an example such a grid is shown in FIG. 1 on the left.

Use of the environmental data especially in a vehicle for a driver assistance system generally requires a binary decision, wherein on the basis of a threshold value it is decided for the probability whether the cell is occupied and thus cannot be crossed by a vehicle or is free and thus can be crossed by a vehicle. Thus, discrete decision classes are relevant which indicate for example with a numerical value or the like the conditions occupied/free for a grid cell. In a positive embodiment of the invention, the creation of the environmental model with the calculation of the binary values of the grid cells or discrete values of the grid cells in case of more than two decision classes is effected by means of a first evaluation or control unit and is then transmitted to a second evaluation or control unit.

In this example of embodiment, the second evaluation and control unit serves for controlling the driver assistance functions, namely e.g. the output of a braking, steering, light controlling or warning signal and the first evaluation and control unit is the evaluation unit of a sensor system for sensing the environment. After discretization or classification of the values stored in the grid cells there are large areas with a high spatial correlation. This is exemplified in FIG. 1. In FIG. 1 on the left a grid prior to discretization of the grid values is shown and in FIG. 1 on the right a grid with discretized values is shown. In FIG. 1 on the right there are now two conditions, namely non-filled or filled grid cells, which form coherent areas. Here, with the application of known compression methods for spatial decorrelation such as e.g. run-length encoding or quad trees a high data compression can be achieved on the discrete values.

The values of the grid cells are updated at predefined intervals. Between successive values of the grid cells in binary (discretized) representation as a rule there is a high temporal correlation, since even with integration of new measurement data the probability in a cell changes, however, in many cases not the assignment to a discrete class on the basis of the threshold value. In a preferred embodiment of the invention by decorrelating the temporal dependence, (i.e. the difference formation of the successive grids) a further strong compression of the data is achieved. This is exemplified in FIG. 2. In FIG. 2 on the left a grid is shown with discretized values of the measurement cycle n. In FIG. 2 on the right a grid is shown with discretized values of the subsequent measurement cycle n+1. If now the difference of the corresponding grid cells “difference grid(n+1)−grid(n)” is formed, it is found that only the discretized value of 3 grid cells has changed. These cells are marked in FIG. 2 on the right with a bold border.

In addition to a lossless compression method or also alone a lossy method can be applied in a further example of embodiment. This can be used on the one hand for a further reduction in the data rate, but also to obtain a constant data rate after the compression, as is usually demanded for automotive applications. Here, areas which are further away from the vehicle are more compressed, since the required accuracy of the environmental modeling decreases with the distance to the vehicle (e.g. parking assistance in relation to transverse guidance on highways). Furthermore, features in particular facing the vehicle are relevant, so that alternatively or additionally, features facing away from the vehicle can be more compressed (e.g. front/back side of a construction site wall). For this in particular a quad tree is suitable, in which in areas further away or facing away from the vehicle such a lossy compression can be achieved by limiting the tree depth.

By transmitting only differences values more computing time can be saved on the application side, i.e. in the evaluation or function control. In particular, the difference data can be transmitted for a recalculation in comparison with the previously valid data.

An important point of the invention is therefore the application of a thresholding prior to the application of compression methods, since only after the thresholding, a high spatial and temporal correlation is present, which enables high compression factors.

It is advantageous that by shifting the thresholding from the function to the calculation of the environmental model compression methods can be applied effectively on the grid-based environmental model, which allow in this way a transmission of the grid-based environmental model via automotive bus systems.

Further advantages can be reductions in memory requirements in the functional control unit as well as reductions in required CPU resources, as after the application of a compression method coherent areas which are equally classified, can be processed in relation with an operation instead of cell by cell. For example, in FIG. 1 on the right two new values would have to be calculated instead of 25 in FIG. 1 on the left.

In a preferred embodiment of the invention the assignment of the discrete value is effected on the basis of the environmental data by means of an assignment table, wherein the assignment table is stored in the memory of the evaluation unit. Consequently, in the assignment table the threshold values are stored, which enables the assignment to a discrete value. An assignment table is exemplified here.

TABLE 1

| Cell value | 0%-25% | 25%-50% | 50%-75% | 75%-100% |
|---|---|---|---|---|
| Classes | 1 | 2 | 3 | 4 |

In particular, for changing the values of a plurality of grid cells preferably all grid cells, only the assignment table is changed with the threshold values. In addition to a linear mapping for the discretization as shown in Table 1, a problem-oriented discretization (e.g. logarithmic) can be used, which in less relevant areas of the continuous input values uses large discretization steps and thus with identical number of discrete classes can finer resolve the relevant areas.

To change the contents of all the cells, the assignment of values in the table is changed. By assigning the new values in Table 2 for the cells, the probability is reduced in all cells without having to adjust the cells in the grid.

TABLE 2

| Cell value | 0%-25% | 25%-50% | 50%-75% | 75%-100% |
|---|---|---|---|---|
| Classes | 1, 2 | 3 | 4 | 5 |

Since a discrete definition range as an input of the application functions for the update results in a finite number of elements in the range of values, it is thus possible to calculate the values in advance and store them in tables, which makes it possible to save more computation time. A further advantage of the representation of functions using tables is the easy verifiability of the input and output values, moreover special cases can be treated by appropriate entries in the table.

1-13. (canceled)

14. A method for a sensor system for sensing the environment of a motor vehicle having an evaluation or control unit, wherein the method comprises:
calculating a grid-based environmental model wherein at least one respective discrete value of environmental data is assigned respectively to each grid cell of a grid of the model,
a discretizing the values by comparing the environmental data with at least one threshold value, and
transmitting at least one discrete value of the grid via a data transmission system to the evaluation or control unit in the vehicle.

15. The method according to claim 14, further comprising applying a lossless compression to the discrete values of the grid.

16. The method according to claim 15, wherein the lossless compression comprises compressing the data by decorrelating the temporal dependence.

17. The method according to claim 14, further comprising applying a lossy compression to the discrete values of the grid.

18. The method according to claim 17, wherein the discrete values of the grid that represent areas further away from the vehicle are more compressed.

19. The method according to claim 17, wherein the discrete values of the grid that represent features facing away from the vehicle are more compressed.

20. The method according to claim 14, wherein the environmental model is calculated and a data compression is applied prior to a data transmission in a vehicle.

21. The method according to claim 14, wherein the assignment of the discrete values is effected on the basis of the environmental data through use of an assignment table, which is stored in a memory of the evaluation or control unit.

22. The method according to claim 21, wherein only the assignment table is changed, for changing the values of a plurality of the grid cells, or in particular all of the grid cells.

23. An apparatus for performing the method according to claim 14, comprising a sensor system for sensing objects in the environment of a vehicle, and comprising a first computing and evaluation unit having a memory on which instructions for carrying out the method are stored.

24. The apparatus according to claim 23, further comprising a second evaluation or control unit and a data transmission system, wherein the first computing and evaluation unit is connected with the second evaluation or control unit via the data transmission system in the vehicle.

25. The apparatus according to claim 24, wherein the first computing and evaluation unit is provided for creating an environmental model and the second evaluation or control unit is provided for controlling a driver assistance system.
